(19) United States
(12) Patent Application Publication
(10) Pub. No.: US 2022/0032483 A1
(43) Pub. Date: Feb. 3, 2022

(54) UTILITY KNIFE BUTTON

(71) Applicant: Hong Ann Tool Industries Co., Ltd., Taichung City (TW)

(72) Inventor: Cheng-Wei SU, Taichung City (TW)

(21) Appl. No.: 17/186,477

(22) Filed: Feb. 26, 2021

(30) Foreign Application Priority Data
Jul. 31, 2020 (TW) 109126041

(51) Int. Cl. B26B 1/10

(52) U.S. Cl. CPC B26B 1/10; B26B 1/08

(57) ABSTRACT

A utility knife button includes a connecting portion and a pressing portion connected to a top end of the connecting portion. The connecting portion is extended along a reference axis and has a connecting end disposed at a bottom end thereof along the reference axis. The pressing portion has a front edge and a rear edge along a radial direction of the reference axis. A top edge of the pressing portion opposite to the connecting portion is provided with a pressing surface. A first length is defined from a proximal end of the pressing surface adjacent to the front edge to the connecting end along the reference axis. A second length is defined from a distal end of the pressing surface adjacent to the rear edge to the connecting end along the reference axis. The first length and the second length are not equal.

### BACKGROUND OF THE INVENTION

The present invention relates to a utility knife button, and more particularly to a utility knife button has a pressing surface that remains completely exposed outside the utility knife after pressed.

Taiwan Utility Model Patent No. M258844 discloses a utility knife structure, which has an arched sleeved block formed at a front end of a rear cover thereof. A closed opening is formed between a side jointing surface of the rear cover and the sleeved block. A positioning slot with a predetermined width is formed on upper and lower sides of the opening, and a knife aperture through which a blade can penetrate. An insert joint piece is extended from a lower portion of a front end of a front cover so that when the front cover and the rear cover are assembled, the insert joint piece can be inserted forward into the positioning slot of the rear cover to provide a front end connection and cooperates with the front cover and the predetermined positions of the rear cover to assembly the front cover and the rear cover.

The push button of The above knife structure must be pressed and pushed to move the blade. When the push button is pressed, a connecting piece between a blade seat and the push button will bend and deform. Because the connecting piece is deformed in a curved manner, only the rear half part of the push button moves down while pressing the push button. Thus, only the front half part of the push button exposed outside the utility knife will cause it difficult to press and push the push button.

Thus, a need exists for a novel utility knife button that mitigates and/or obviates the above drawbacks.

### BRIEF SUMMARY OF THE INVENTION

A utility knife button according to the present invention includes a connecting portion and a pressing portion. The connecting portion is extended along a reference axis and has a connecting end disposed at a bottom end thereof along the reference axis. The pressing portion is connected to a top end of the connecting portion. The pressing portion has a front edge and a rear edge along a radial direction of the reference axis. A top edge of the pressing portion opposite to the connecting portion is provided with a pressing surface. A first length is defined from a proximal end of the pressing surface adjacent to the front edge to the connecting end along the reference axis. A second length is defined from a distal end of the pressing surface adjacent to the rear edge to the connecting end along the reference axis. The first length and the second length are not equal.

In an example, the first length is less than the second length.

In an example, a radial width of the pressing portion along the radial direction of the reference axis is greater than a radial width of the connecting portion along the radial direction of the reference axis. A bottom edge of the pressing portion adjacent to the connecting portion is provided with a stopping surface. A third length is defined from a first end of the stopping surface adjacent to the front edge to the connecting end along the reference axis. A fourth length is defined from a second end of the stopping surface adjacent to the rear edge to the connecting end along the reference axis. The third length is less than the fourth length.

In an example, the connecting portion has a first section disposed adjacent to the connecting end and a second section disposed between the first section and the pressing portion. A first width is defined between two opposite sides of the first section along the radial direction of the reference axis. A second width is defined between two opposite sides of the second section along the radial direction of the reference axis. The first width is less than the second width.

In an example, the connecting portion further has a third section connected to the second section and the stopping surface. A third width is defined between two opposite sides of the third section along the radial direction of the reference axis. The second width is less than the third width.

The present invention will become clearer in light of the following detailed description of illustrative embodiments of this invention described in connection with the drawings.

### DESCRIPTION OF THE DRAWINGS

FIG. 1 is a perspective view of a utility knife button of a embodiment according to the present invention.

FIG. 2 is a perspective view of the utility knife button of FIG. 1 and illustrates the utility knife button mounted to a utility knife.

FIG. 3 is a cross sectional view of FIG. 2.

FIG. 4 is a continued view of FIG. 3 and illustrates the utility knife button being pressed.

### DETAILED DESCRIPTION OF THE INVENTION

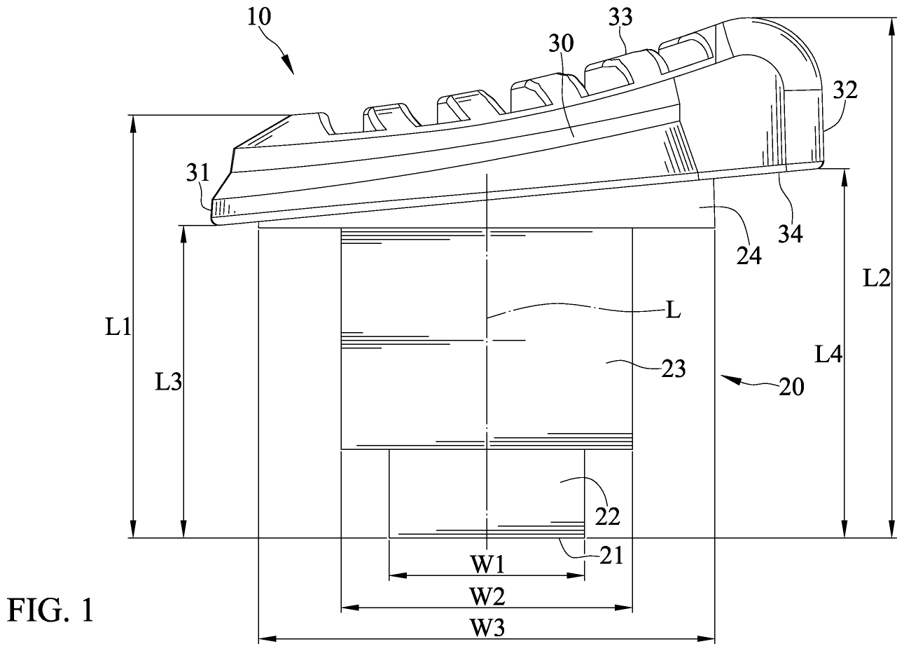

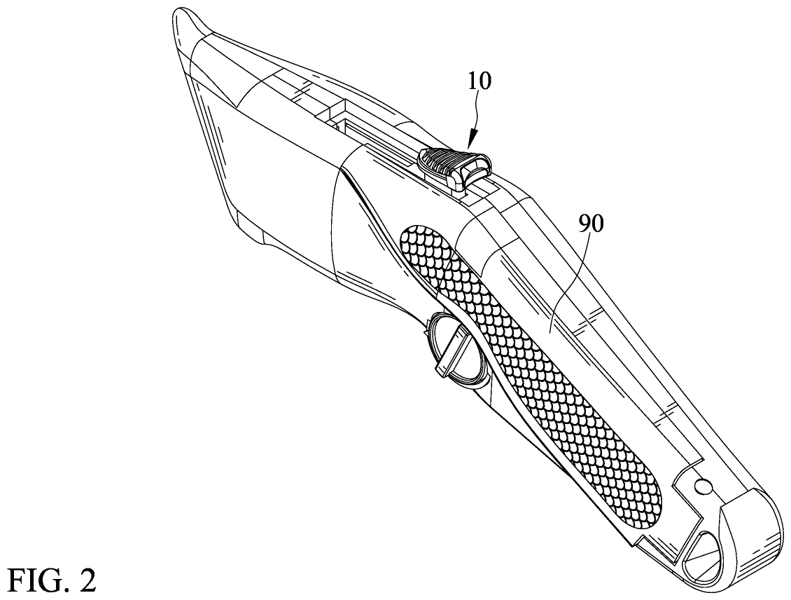

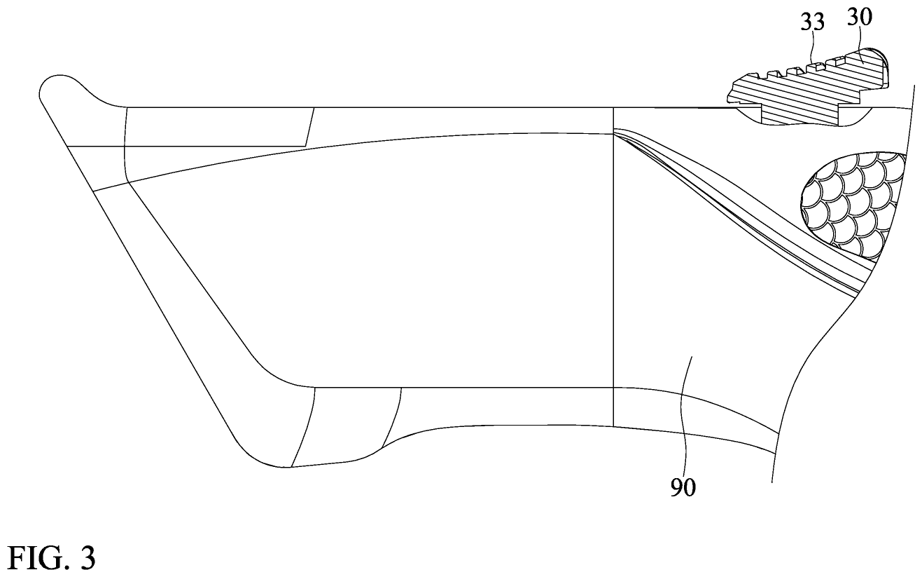

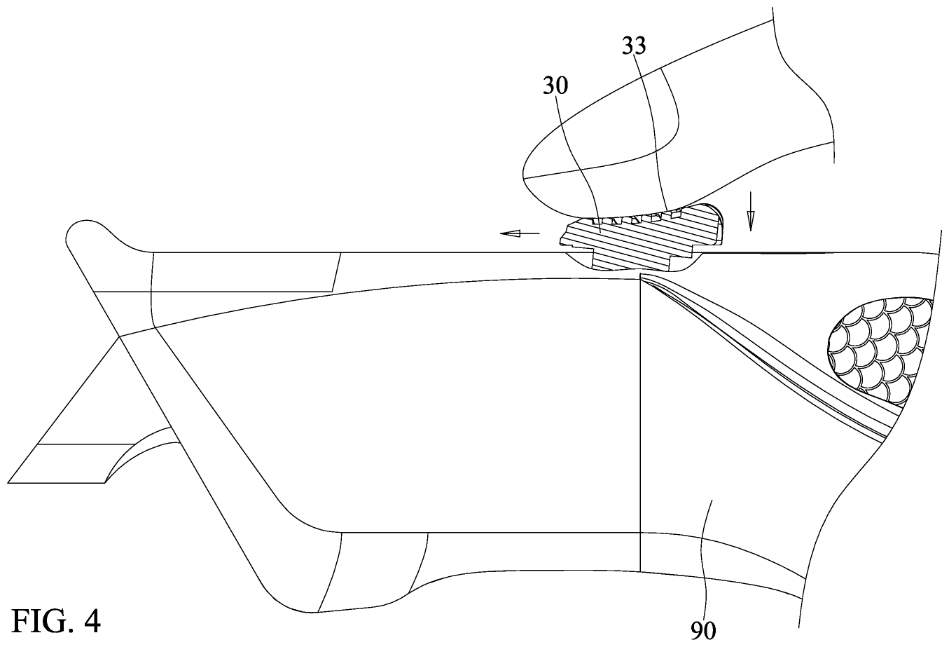

FIGS. 1-4 show a utility knife button 10 of a embodiment according to the present invention. The utility knife button 10 includes a connecting portion 20 and a pressing portion 30.

The connecting portion 20 is extended along a reference axis L and has a connecting end 21 disposed at a bottom end thereof along the reference axis L.

The pressing portion 30 is connected to a top end of the connecting portion 20. The pressing portion 30 has a front edge 31 and a rear edge 32 along a radial direction of the reference axis L. A top edge of the pressing portion 30 opposite to the connecting portion 20 is provided with a pressing surface 33. A first length L1 is defined from a proximal end of the pressing surface 33 adjacent to the front edge 31 to the connecting end 21 along the reference axis L. A second length L2 is defined from a distal end of the pressing surface 33 adjacent to the rear edge 32 to the connecting end 21 along the reference axis L. The first length L1 and the second length L2 are not equal.

In the embodiment, the first length L1 may be less than the second length L2.

A radial width of the pressing portion 30 along the radial direction of the reference axis L is greater than a radial width of the connecting portion 20 along the radial direction of the reference axis L. A bottom edge of the pressing portion 30 adjacent to the connecting portion 20 is provided with a stopping surface 34. A third length L3 is defined from a first end of the stopping surface 34 adjacent to the front edge 31 to the connecting end 21 along the reference axis L. A fourth length L4 is defined from a second end of the stopping surface 34 adjacent to the rear edge 32 to the connecting end 21 along the reference axis L. The third length L3 is less than the fourth length L4.

The connecting portion 20 has a first section 22 disposed adjacent to the connecting end 21 and a second section 23 disposed between the first section 22 and the pressing portion 30. A first width W1 is defined between two opposite sides of the first section 22 along the radial direction of the reference axis L. A second width W2 is defined between two opposite sides of the second section 23 along the radial direction of the reference axis L. The first width W1 is less than the second width W2.

The connecting portion 20 further has a third section 24 connected to the second section 23 and the stopping surface 34. A third width W3 is defined between two opposite sides of the third section 24 along the radial direction of the reference axis L. The second width W2 is less than the third width W3.

The utility knife button 10 can be mounted on the utility knife 90. After the utility knife button 10 is pressed, the pressing surface 33 is still completely exposed outside the utility knife 90, so as to prevent the pressing surface 33 from moving down too deep and difficult to move. Further, the stopping surface 34 is inclined to promote the utility knife button 10 more closely surface-contact the utility knife 90 after being pressed.

Although specific embodiments have been illustrated and described, numerous modifications and variations are still possible without departing from the scope of the invention. The scope of the invention is limited by the accompanying claims.

1. A utility knife button comprising:
a connecting portion extended along a reference axis and having a connecting end disposed at a bottom end thereof along the reference axis; and
a pressing portion connected to a top end of the connecting portion, wherein the pressing portion has a front edge and a rear edge along a radial direction of the reference axis, wherein a top edge of the pressing portion opposite to the connecting portion is provided with a pressing surface, wherein a first length is defined from a proximal end of the pressing surface adjacent to the front edge to the connecting end along the reference axis, wherein a second length is defined from a distal end of the pressing surface adjacent to the rear edge to the connecting end along the reference axis, and wherein the first length and the second length are not equal.

2. The utility knife button as claimed in claim 1, wherein the first length is less than the second length.

3. The utility knife button as claimed in claim 2, wherein a radial width of the pressing portion along the radial direction of the reference axis is greater than a radial width of the connecting portion along the radial direction of the reference axis, wherein a bottom edge of the pressing portion adjacent to the connecting portion is provided with a stopping surface, wherein a third length is defined from a first end of the stopping surface adjacent to the front edge to the connecting end along the reference axis, wherein a fourth length is defined from a second end of the stopping surface adjacent to the rear edge to the connecting end along the reference axis, and wherein the third length is less than the fourth length.

4. The utility knife button as claimed in claim 3, wherein the connecting portion has a first section disposed adjacent to the connecting end and a second section disposed between the first section and the pressing portion, wherein a first width is defined between two opposite sides of the first section along the radial direction of the reference axis, wherein a second width is defined between two opposite sides of the second section along the radial direction of the reference axis, and wherein the first width is less than the second width.

5. The utility knife button as claimed in claim 3, wherein the connecting portion further has a third section connected to the second section and the stopping surface, wherein a third width is defined between two opposite sides of the third section along the radial direction of the reference axis, and wherein the second width is less than the third width.
